(19) United States
(12) Patent Application Publication
(10) Pub. No.: US 2008/0062454 A1
(43) Pub. Date: Mar. 13, 2008

(54) SECURE PRINTER MANAGEMENT AND OUTPUT OPTIONS

(75) Inventors: James E. Bostick, Cedar Park, TX (US); Randolph M. Forlenza, Austin, TX (US); John P. Kaemmerer, Pflugerville, TX (US); Raghuraman Kalyanaraman, Austin, TX (US)

Correspondence Address: CANTOR COLBURN LLP - IBM AUSTIN, 20 Church Street, 22nd Floor, Hartford, CT, 06103, US

(73) Assignee: INTERNATIONAL BUSINESS MACHINES CORPORATION, Armonk, NY (US)

(21) Appl. No.: 11/530,235

(22) Filed: Sep. 8, 2006

(51) Int. Cl. G06F 3/12

(52) U.S. Cl. 358/1.15

(57) ABSTRACT

A system and method for an imaging device adaptable to network communications for receiving an imaging job, and alerting a user when the imaging job is completed is provided. The imaging device includes a secure storage area for storing the imaged job and an access code validator connectable to an access code database for allowing access the secure storage area. The imaging device also includes resources and logic for emailing notifications and alerts to the user. The system and method also include access attempts and document retrieval time keyed to priority codes received with the imaging job.

### TRADEMARKS

IBM® is a registered trademark of International Business Machines Corporation, Armonk, N.Y., U.S.A. Other names used herein may be registered trademarks, trademarks or product names of International Business Machines Corporation or other companies.

### BACKGROUND OF THE INVENTION

1. Field of the Invention

This invention relates in general to network printers and in particular to a method and system for remotely sending print jobs to be printed and secured in a secure storage area for later retrieval by authorized personnel.

2. Description of the Related Art

In a corporate environment, using Network Printers is very common. Under most circumstances, when a document is submitted for printing, the user can wait for the system to send a message, such as “Print completed”, and at some later point walk to the printer room and collect the documents. In the case of many documents there may or may not be a compelling need to pickup the printer output immediately.

However, leaving printed documents around the printer for extended periods of time is usually against corporate printing security policies and procedures where confidential documents are concerned. This is because confidential printouts could be lying around for quite some time and could be read, copied, or stolen by unauthorized personnel before the user picks them up. Having a secure printer room does not solve this problem because even the people authorized for printer room access may not be entitled to read any particular confidential document.

Current process or actions to avoid violating policy and procedures for printing confidential documents and ensure that confidential documents are picked up immediately after they have finished printing requires manual and timely action by the user. For example, the user might go to the printer room immediately after submitting the job, or as soon as a “print complete” notification is issued, and wait until the printing is done. The wait time can vary depending on the queue size, whether the printer is down, whether toner and paper are adequate, etc. This can be annoying, wasteful, and time consuming especially when the output runs to hundreds of pages or there is a system or mechanical problem with the printer.

If the printer is jammed or otherwise broken, the user may not have any idea of how long it will be before the printer is fixed and the confidential documents are printed. The user may not even be on the premises when the output appears and travel time to the printer location may exceed the time allowed by corporate printing guidelines.

Users might want to issue print commands remotely (for example, from their home or hotel) outside of normal working hours and later that day, or the next day, drive to work and pick up their confidential printouts. Currently, printing confidential documents using the company's network printer may be out of the question for those who want to print from home but pick up the output at some later time.

What are needed are improved options for providing document security in a shared printer environment.

### SUMMARY OF THE INVENTION

The shortcomings of the prior art are overcome and additional advantages are provided through the provision of an imaging device adaptable to network communications for receiving an imaging job, and alerting a user when the imaging job is completed, is provided. The imaging device includes a secure storage area for storing the imaged job and an access code validator connectable to an access code database for allowing access the secure storage area. The imaging device also includes resources and logic for emailing notifications and alerts to the user.

The invention is also directed towards method for imaging, securing, and retrieving an image request from a user. The method includes electronically receiving the image request, which includes receiving an image job; receiving imaging instructions; receiving a priority code; and receiving a user identifier. The method also includes imaging the image job in accordance with the imaging instructions received with the image request and emailing the user an image job status, e.g., job done, ink low, paper out, etc. The method further includes storing the imaged job in a secure container; and only allowing authorized persons to retrieve the imaged job from the secure container.

System and computer program products corresponding to the above-summarized methods are also described and claimed herein.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### TECHNICAL EFFECTS

As a result of the summarized invention, technically we have achieved a solution which tangibly embodies a program of instructions stored within a program storage device readable by a machine, and executable by the machine to perform a method for imaging, securing, and retrieving an image request from a user. The method includes electronically receiving the image request, which includes receiving an image job; receiving imaging instructions; receiving a priority code; and receiving a user identifier. The method also includes comparing the user identifier, a user digital certificate, with a local identifier database and emailing an alert as result of the comparison. The method further includes imaging the image job in accordance with the imaging instructions and emailing the user an image job status. The method continues to store the imaged job in a secure container and allows an authorized user to retrieve the imaged job from the secure container. The method checks authorization by having the user enter an access code, swipe a badge, or check the user's biometric identification, (e.g., fingerprints) or via any other secure mechanism. The method also sets an access attempt counter keyed to the priority code received with the image request and alerts appropriate personnel if the number of access attempts exceeds the attempt counter threshold. In addition, the method includes a print job completed timer which could send an alert if the imaged job is not retrieved within a set time. The set time is also correlated with priority code.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 is a pictorial representation of a data processing system which may be utilized to implement a method and system of the present invention; and

FIG. 2 is a flowchart showing exemplary behavior of the secure printer management and output options in accordance with the embodiment shown in FIG. 1.

The detailed description explains the preferred embodiments of the invention, together with advantages and features, by way of example with reference to the drawings.

### DETAILED DESCRIPTION OF THE INVENTION

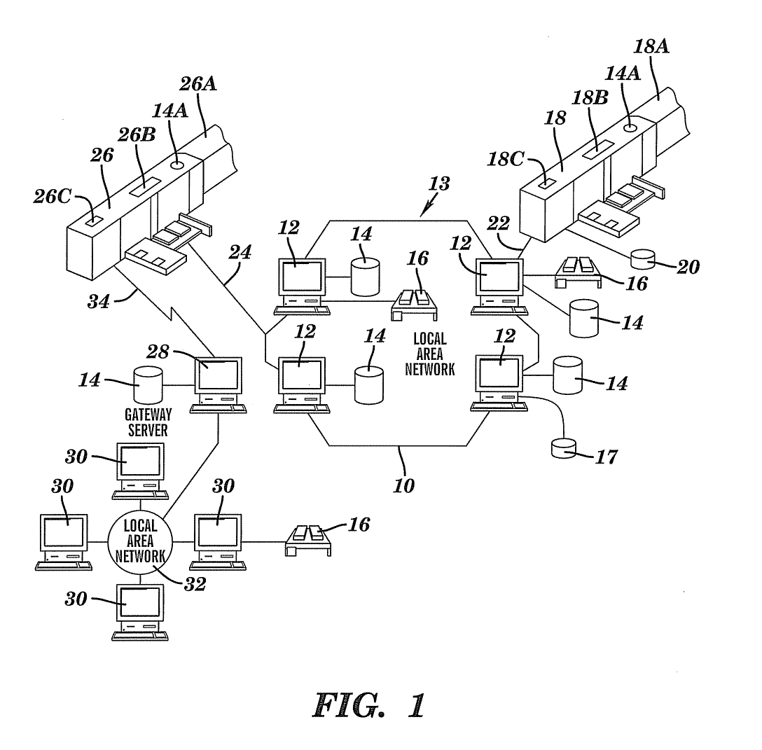

Turning now to the drawings in greater detail, it will be seen that in FIG. 1 there is depicted a graphical representation of a data processing system 8, which may be utilized to implement the present embodiment. As may be seen, data processing system 8 may include a plurality of networks, such as Local Area Networks (LAN) 10 and 32, each of which preferably includes a plurality of individual computers 12 and 30, respectively. Of course, those skilled in the art will appreciate that a plurality of Intelligent Work Stations (IWS) coupled to a host processor may be utilized for each such network. Each said network may also consist of a plurality of processors coupled via a communications medium, such as shared memory, shared storage, or an interconnection network. As is common in such data processing systems, each individual computer may be coupled to at least one of a storage device 14 and a local printer 16 and may be provided with a pointing device such as a mouse 17.

As used herein, an “imaging device” includes any device for providing document output. Typical imaging devices, and the exemplary imaging device discussed herein include a network printer. However, one skilled in the art will recognize that the teachings herein may be used with a variety of devices other than network printers. Accordingly, network printers are merely illustrative of certain embodiments for imaging devices.

The data processing system 8 may also include multiple printing or imaging devices, such as network printer 18, which may be preferably coupled to LAN 10 by means of communications link 22. The mainframe computer 18 may also be coupled to a storage device 20 which may serve as remote storage for LAN 10. Similarly, LAN 10 may be coupled via communications link 24 to a network printing or imaging device 26 and communications link 34 to a gateway server 28. It will be appreciated that network printer 18 will also contain resources and logic features for emailing status, alerts, and/or notifications via any suitable communications link to a remote user in accordance with embodiments of the present invention.

Network printer 18 also includes secure storage area 18A for the storage of printed documents. Documents are retrieved from the secure storage area 18A by network printer 18 after identifying access code is entered through access code validator 18C, or selected from access code database 14A via input control window 18B. It will be appreciated that access codes may be entered into network printer by any suitable means, such as a keypad, optical character recognition, magnetic data transfer, or a biometric device such as a fingerprint reader or optical scanner. It will also be appreciated that access code database 14A need not be collocated with network printer 18 but may be geographically remote and connectable to the network printer 18 via LAN 10.

Similarly, network printer 26 also includes secure storage area 26A for the storage of printed documents. Documents are retrieved from the secure storage area 26A by network printer 26 after identifying access code is entered through access code validator 26C, or selected from access code database 14A via input control window 26B. It will be appreciated that access codes may be entered into network printer by any suitable means, such as a keypad, optical character recognition, or magnetic data transfer. It will also be appreciated that access code database 14A need not be collocated with network printer 26 but may be geographically remote and connectable to the network printer 26 via gateway server 28. It will be further appreciated that network printer 26 will also contain resources and logic features for emailing status, alerts, and/or notifications via any suitable communications link (e.g., link 22), to a remote user, in accordance with various embodiments of the teachings herein.

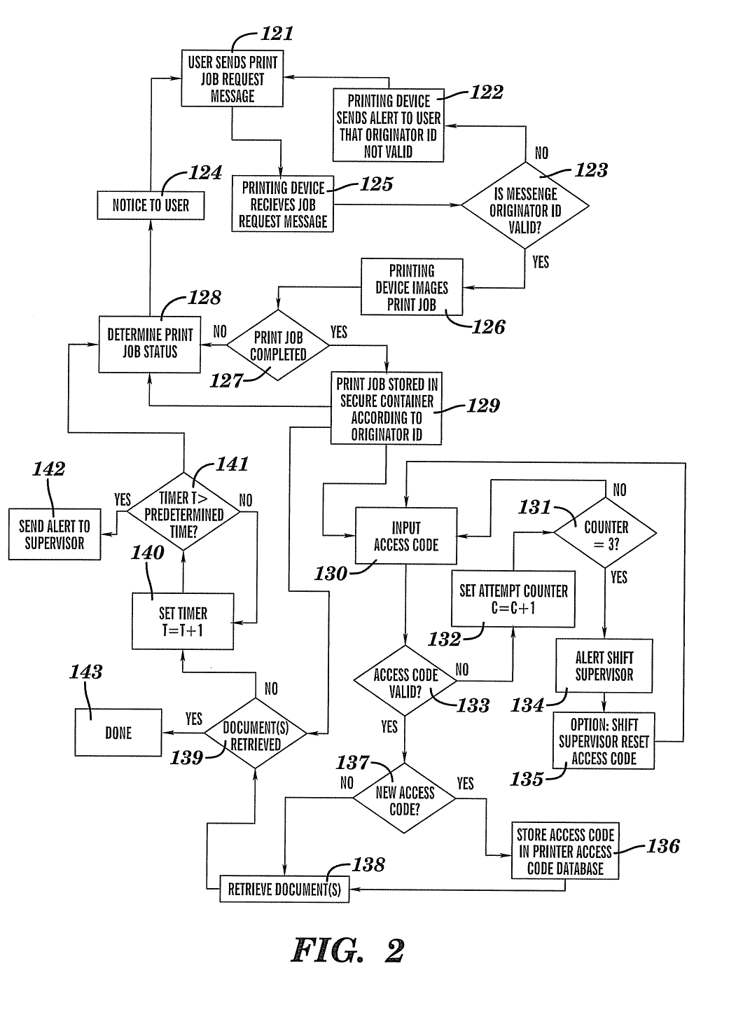

Referring also to FIG. 2 there is shown a flowchart depicting behavior of the secure printer management and output options in accordance with the present embodiment shown in FIG. 1. In block 121, a user sends a print job request to one or both of the network printers 18, 26 (shown in FIG. 1). It will be appreciated that the job request message includes the data to be printed as well as identifying information such as corresponding access codes for later retrieval of the printed data as well as return or proxy email addresses. It will be appreciated that any suitable identifying information may be contained in the job request message such as, for example, one or more uniform resource locators (URLs). For clarity the rest of the description will reference one of the network printers but it will be understood that either or both of the network printers will operate similarly in accordance with the present embodiments.

In block 125, the system 8 receives the job request message, including identifying information and priority status. Decision block 123 then determines if the originator or user identifying information is valid. It will be appreciated that user identifying information may be validated by comparing email address, access codes, or similar identifying information, (e.g., digital certificates, with identifying information stored in a company database (not shown)) or in the access code database 14A, shown in FIG. 1.

If the answer to decision block 123 is no, then printing device 26 emails an alert 122 back to the user indicating that the identifying information is not valid. It will be appreciated that an alert or notification from the printer device 26 may be sent by any suitable means. If the answer to decision block 123 is yes, then printing device 26 images, or prints or images job 126.

It will be appreciated that the print job may be interrupted for various reasons, such as out of paper, out of ink, etc. In decision block 127, the system 8 determines if the print job has completed. If the answer to decision block 127 is no, then the system 8 determines the status of the print job in block 128. Block 124 indicates notification (such as by emailing of the status) of the status back to the user with a priority equivalent to the priority received as part of the identifying information, block 125.

If the answer to decision block 127 is yes, the print job is stored, as indicated in block 129, in secure container storage area 26A. It will be appreciated that multiple print jobs may be grouped, stored, and retrieved, according to the originator's or user's ID, or any other suitable grouping index. In addition, once a print job is complete, in decision block 139, the system 8 determines if the printed documents have been retrieved. Decision block 139 is further described below.

As indicated in block 130, in order to retrieve the print job, a user (or other authorized person) inputs an access code, via access code validator 26C. It will be appreciated that inputting an access code can be accomplished by any suitable means such as keypad entry, badge recognition, or biometric scanning. In decision block 133, the system 8 determines if the access code is valid by comparing the inputted access code with codes stored in the access code database 14A (or any other suitable database, such as, for example, a company email directory), or digital certificates used to authenticate network users. If the answer to decision block 133 is no, then in block 132 the system 8 sets an attempt counter to 1.

In decision block 131, the system 8 determines if a predetermined number (e.g., three) access attempts have made. If the answer to decision block 131 is no (three access attempts have not been made) then the user is permitted to male another attempt, as indicated in block 130. If the answer to decision block 131 is yes, (e.g., three access attempts have been made), then the system 8 alerts the shift supervisor and/or any other appropriate persons or departments, such as a security office in block 134. It will be appreciated that the number of attempts may be any suitable number. For example, documents with a higher classification may only allow one attempt while documents with a lower classification may allow more attempts for retrieving the print job.

In block 135, the system 8 allows the shift supervisor the option of resetting the user's access code after determining the user's authorization status for retrieving the print job.

If the answer to decision block 133 is yes, then in decision block 137 the system 8 determines if the access code is a new code. If the access code is new code, the code may be stored in the printer access code database as per block 136.

In block 138, the system 8 allows the user to retrieve their printed documents from the secure storage area 26A.

In block 139, the system 8 determines if the printed documents have been retrieved from the secure storage area 26A. If the answer to block 139 is no, then a timer is set by block 140.

In decision block 141, the system 8 determines if the time elapsed has exceeded a predetermined threshold. If the answer to block 141 is no (the timer has not exceeded a predetermined threshold) the timer is again incremented via block 140 and decision block 141 again determines if the time elapsed has exceeded a predetermined threshold. This loop between blocks 140 and 141 continues until block 141 determines that the predetermined threshold has been reached or exceeded or, in other words, the answer to decision block 141 is yes. When the answer to decision block 139 is yes, the system 8 is done, as indicated by block 143.

If the answer to decision block 141 is yes, block 142 sends an alert to the shift supervisor (or any other suitable destination such as, for example, a security office). It will be appreciated that the predetermined time threshold indicated in decision block 141 for retrieving documents printed and stored in secure storage area 126A may be any suitable predetermined time. For example, the predetermined time may be correlated with the priority status or classification of the printed document. In other words, and for example purposes only, a printed document having a high classification may have a short predetermined amount of time for retrieving the printed document from the secure storage area before a shift supervisor is alerted.

In typical embodiments, the system 8 makes distinctions between documents requiring security and documents that do not require security. In these typical embodiments, the foregoing security measures are not applied to documents not requiring security.

The capabilities of the present invention can be implemented in software, firmware, hardware or some combination thereof.

As one example, one or more aspects of the present invention can be included in an article of manufacture (e.g., one or more computer program products) having, for instance, computer usable media. The media has embodied therein, for instance, computer readable program code means for providing and facilitating the capabilities of the present invention. The article of manufacture can be included as a part of a computer system or sold separately.

Additionally, at least one program storage device readable by a machine, tangibly embodying at least one program of instructions executable by the machine to perform the capabilities of the present invention can be provided.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

While the preferred embodiment to the invention has been described, it will be understood that those skilled in the art, both now and in the future, may make various improvements and enhancements which fall within the scope of the claims which follow. These claims should be construed to maintain the proper protection for the invention first described.

What is claimed is:

1. An imaging device adaptable to network communications for receiving an imaging job and alerting a user when the imaging job is completed, the imaging device comprising:
at least one secure storage area for storing the imaged job;
an access code validator for allowing access to the at least one secure storage area;
an access code database connectable to the access code validator; and
resources and logic for emailing notifications and alerts to the user.

2. The imaging device as in claim 1, wherein the access code validator comprises a keypad.

3. The imaging device as in claim 1, wherein the access code validator comprises a badge reader.

4. The imaging device as in claim 1, wherein the access code validator comprises a biometric identifier.

5. The imaging device as in claim 1, wherein the access code database comprises email addresses for comparison with the user's email address.

6. The imaging device as in claim 1, wherein the access code database comprises at least one digital certificate used to authenticate the user.

7. The imaging device as in claim 6, wherein the access code database comprises job priority codes associated with the at least one digital certificate.

8. The imaging device of claim 1, wherein the imaging job comprises one of a document requiring security and a document that does not require security.

9. A method for imaging, securing, and retrieving an image request from a user, the method comprising:
electronically receiving the image request, wherein electronically receiving the image request includes:
receiving an image job;
receiving imaging instructions;
receiving a priority code; and
receiving a user identifier;
imaging the image job in accordance with the imaging instructions received with the image request;
emailing the user an image job status;
storing the imaged job in a secure container; and
retrieving the imaged job from the secure container.

10. The method as in claim 9, wherein electronically receiving the image request further comprises comparing the user identifier with a local identifier database and emailing an alert as result of the comparison.

11. The method as in claim 10, wherein comparing the user identifier with the local identifier database further comprises comparing a user digital certificate with the local identifier database.

12. The method as in claim 10, wherein comparing the user identifier with the local identifier database further comprises comparing a user email address with the local identifier database.

13. The method as in claim 9, wherein retrieving the imaged job from the secure container further comprises:
entering an access code;
determining a validity of the access code by comparing the access code with a pre-populated access code database;
gaining access to the secure container based upon the validity of the access code.

14. The method as in claim 9, wherein entering the access code comprises:
setting an access attempt counter;
setting a predetermined access attempt threshold; and
sending an access alert when the access attempt counter exceeds the predetermined access attempt threshold.

15. The method as in claim 14, wherein setting the predetermined access attempt threshold comprises correlating the predetermined access attempt threshold with the priority code.

16. The method as in claim 9, wherein retrieving the imaged job from the secure container further comprises:
starting a print job completed timer;
setting a predetermined timer threshold; and
sending an alert when the print job completed timer exceeds the predetermined timer threshold.

17. The method as in claim 16, wherein setting the predetermined timer threshold comprises correlating the predetermined timer threshold with the priority code.

18. The method as in claim 16, wherein sending the alert when the print job completed timer exceeds the predetermined threshold further comprises emailing a supervisor correlated with the user.

19. A program storage device readable by a machine, tangibly embodying a program of instructions executable by the machine to perform a method for imaging, securing, and retrieving an image request from a user, the method comprising:
electronically receiving the image request, wherein electronically receiving the image request includes:
receiving an image job;
receiving imaging instructions;
receiving a priority code;
receiving a user identifier;
comparing the user identifier with a local identifier database and emailing an alert as result of the comparison, wherein comparing the user identifier with the local identifier database further comprises:
comparing a user digital certificate with the local identifier database;
imaging the image job in accordance with the imaging instructions received with the image request;
emailing the user an image job status;
storing the imaged job in a secure container;
retrieving the imaged job from the secure container, wherein retrieving the imaged job further comprises;
entering an access code, wherein entering the access code comprises:
determining a validity of the access code by comparing the access code with a pre-populated access code database;
setting an access attempt counter;
setting a predetermined access attempt threshold, wherein setting the predetermined access attempt threshold comprises correlating the predetermined access attempt threshold with the priority code;
sending an access alert when the access attempt counter exceeds the predetermined access attempt threshold;
gaining access to the secure container based upon the validity of the access code;
starting a print job completed timer, wherein starting the print job time comprises:
setting a predetermined timer threshold, wherein setting the predetermined timer threshold comprises correlating the predetermined timer threshold with the priority code; and
sending an alert when the print job completed timer exceeds the predetermined timer threshold, wherein sending the alert when the print job completed timer exceeds the predetermined threshold further comprises emailing a supervisor correlated with the user.
